(19) United States
(12) Patent Application Publication
(10) Pub. No.: US 2009/0180418 A1
(43) Pub. Date: Jul. 16, 2009

(54) METHOD AND BASE STATION FOR TERMINAL MOVING IN MULTICAST BROADCAST SYSTEM

(76) Inventors: Wei ZHANG, Shenzhen (CN); Jianjun Wu, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/405,738

(22) Filed: Mar. 17, 2009

Related U.S. Application Data
(63) Continuation of application No. PCT/CN2007/070803, filed on Sep. 27, 2007.

(30) Foreign Application Priority Data
Sep. 27, 2006 (CN) 200610141725.8
Feb. 15, 2007 (CN) 200710084531.3

(51) Int. Cl. H04H 20/71

(52) U.S. Cl. 370/312

(57) ABSTRACT

A method and a base station (BS) for a terminal to move in a multicast broadcast system are disclosed. The method and the BS maintain the continuity of a multicast broadcast service (MBS) when a terminal in an IDLE mode moves within an MBS zone or among different MBS zones or different paging groups. After the start of the MBS, when the terminal in the IDLE mode moves from an original BS to the coverage of a target BS in the same MBS zone and the same paging group, if the terminal does not receive the MBS or the terminal determines that the target BS does not provide the MBS or provides the MBS in a PTP mode, the terminal notifies the information about the MBS that the terminal needs to receive to the target BS through a location update procedure.

The application is a continuation of international application number PCT/CN2007/070803, filed on Sep. 27, 2007, and claims the benefit of priority to Chinese Patent Applications No. 200610141725.8 and 200710084531.3, respectively filed on Sep. 27, 2006 and on Feb. 15, 2007, and both titled “METHOD AND BASE STATION FOR TERMINAL MOVING IN MULTICAST BROADCAST SYSTEM”, which are incorporated herein by reference in their entirety.

### FIELD OF THE INVENTION

The present invention relates to the wireless communication field, and more particularly, to a Multicast Broadcast Service (MBS) technology.

### BACKGROUND OF THE INVENTION

With the progress of communication technologies and the increase of user requirements, data service has developed rapidly. The rapid increase in the amount of data traffic has resulted in higher requirements for communication bandwidth. Accordingly, broadband access has shown great market potential to serve this industry. In order to break the bandwidth bottleneck of the access network, various broadband access technologies are thus proposed.

Worldwide Interoperability for Microwave Access (WiMAX) is a wireless metropolitan area network (MAN) access technology based on the Institute of Electrical and Electronics Engineers (IEEE) 802.16 standard series in this industry, which basically aims to provide a broadband wireless access means featuring effective interoperability under a point to multipoint (PTM) multi-vendor environment in the MAN. A WiMAX network may be composed of three parts, namely, a client (terminal), an Access Service Network (ASN), and a Connectivity Service Network (CSN), and includes logic entities such as a Prepaid Service (PPS) server and an Authentication Authorization and Accounting Server (AAA Server). The ASN includes Base Stations (BSs) and an Access Service Network Gateway (ASN GW). The WiMAX network now conforms to the IEEE 802.16-2004 (802.16d) standard proposed on July, 2004. The working frequency band of the IEEE 802.16-2004(802.16d) standard is between 2 GHz and 11 GHz, which is a hybrid of authorized and unauthorized frequency bands. The physical layer of the IEEE 802.16-2004 (802.16d) standard employs Orthogonal Frequency Division Multiplexing (OFDM) and Orthogonal Frequency Multiple Access (OFDMA) technologies, and is capable of overcoming the multi-path fading. Under optimal channel fading, the standard may have a transmission rate up to 75 Mbps.

The logic structure of the WiMAX network is shown in FIG. 1. An interface RI is a radio air interface, and is mainly defined by IEEE802.16d/e. Other interfaces are wired interfaces.

The WiMAX network is briefly described above, and the Multicast Broadcast Service (MBS) will be illustrated below.

With the rapid development of the Internet, people require not only telephone and message services in mobile communication, many demand multimedia services. For example, some application services allow multiple users to receive the same data simultaneously, such as video on demand, TV broadcast, video conferencing, online education, and interactive gaming. Currently, the services may be realized through an Internet Protocol (IP) multicast and broadcast technology in the wired network. However, if these services are enabled on the mobile network, because of the large amount of data and long duration, they may be delay sensitive as compared with the common data. Further, the mobile network has special network structures, function entities, radio interfaces, etc., limiting the direct application of existing IP multicast and broadcast technology to the mobile network.

In order to effectively use the mobile network resources, the WiMAX defines the MBS. The MBS is a point-to-multipoint (PTM) service in which one data source is provided in the mobile network to send data to multiple users, so as to realize shared network resources and improve the utilization of the network resources, especially the air interface resources. The MBS defined by the WiMAX realizes not only the multicast and broadcast of pure text messages at a low rate, but also the multicast and broadcast of high-rate multimedia services, which undoubtedly conforms to the development trend of the mobile data services.

In the WiMAX network, a Service Flow Identifier (SFID) is used to identify different unidirectional service flows, and a Connection ID (CID) is used to identify different connections. All service flows are transferred at the air interface through a Medium Access Control (MAC) layer connection, and transmitted to corresponding connections through the mapping between the SFIDs of the service flows and the CIDs of the MAC layer connection. On the basis of the above IDs, the MBS based on the WiMAX network also identifies the multicast connection through a Multicast CID, and identifies a multicast service through an MBS Contents ID, in which a Protocol Data Unit (PDU) transmitted on one Multicast CID may include one or more MBSs.

In the MBS, some globally defined service flows may carry the broadcast or multicast information to multiple terminals/subscriber stations (SSs), and include the QoS parameters. The service flows may be encrypted with a globally defined encryption key to improve the security of the services.

The MBS based on the WiMAX network supports two access modes, namely, single-BS access and multi-BS access. In the multi-BS access mode, all BSs in one MBS zone (identified by an MBS_zone ID) use the same Multicast CID and MBS Group Security Association (MBS GSA) ID, and send the contents of the same MBS flow. The terminal that has registered with the MBS may receive the data of the MBS through multiple BSs in the MBS zone.

In the prior art, according to the description of the 802.16e-2005 protocol, for the MBS in the multi-BS access mode, the terminal can receive the data of the MBS through multiple BSs in the MBS zone, in addition, the terminal in an IDLE mode may receive the MBS normally without re-accessing the network or reestablishing the MBS connection when moving in the MBS zone among different BSs, thus realizing the seamless handoff of the MBS.

However, in actual applications, the following problem may occur. In some circumstances, after the terminal moves to the coverage of another BS in the MBS zone according to the description of the 802.16e-2005 protocol, the terminal may not be served for a long time.

The main reasons for this problem lie in that the 802.16e protocol does not describe the process and detailed steps of keeping the MBS when the terminal in the IDLE mode moves in the MBS zone. In some special situations, if the terminal in the IDLE mode moves from an original serving BS to the coverage of another BS in the same MBS zone after the session starts, the terminal will not execute the location update because the target BS belongs to the same paging group as the original BS. If the target BS does not provide the service in a point-to-multipoint (PTM) mode because no user receives the MBS or the number of the users using the service is smaller than a threshold, the terminal in the IDLE mode may be unable to obtain the required service. For example, before the session starts, when the terminal in the IDLE mode that has joined the service moves to the coverage of another BS in the same paging group of the same MBS zone, if the target BS to which the terminal moves does not provide the service because no other terminals use the MBS, and the target BS still does not sense the existence of the terminal, the target BS will not provide the corresponding MBS to the terminal moved to the coverage thereof. As a result, the terminal can obtain the required MBS only after a periodic location update or a periodic user statistics initiated by the BS.

### SUMMARY

Accordingly, an embodiment of the present invention is directed to provide a method and a base station for a terminal to move in a multicast broadcast system, so as to keep continuity of a multicast broadcast service (MBS) when a terminal in an IDLE mode moves.

An embodiment of the present invention provides a method for a terminal to move in a multicast broadcast system, which includes the following steps.

A target base station (BS) acquires information of an MBS that a terminal in an IDLE mode needs to receive.

The corresponding MBS is provided to the terminal according to the acquired information.

An embodiment of the present invention further provides a base station, which includes an information acquiring module and a service providing module.

The information acquiring module is adapted to acquire information about an MBS that a terminal needs to receive when the terminal in an IDLE mode moves to a coverage of a target BS.

The service providing module is adapted to provide the MBS for the terminal according to the information acquired by the information acquiring module.

It can be seen that, according to the embodiments of the present invention, when the terminal in the IDLE mode moves among different paging groups, a location update procedure is initiated, and the procedure notifies the information about the MBS that the terminal needs to receive to the target BS, so that the target BS is capable of providing the corresponding MBS for the terminal according to the acquired information. Therefore, the continuity of the MBS is ensured when the terminal moves among different MBS zones or different paging groups, thus preventing the problem that the terminal is not served for a long time after moving.

### BRIEF DESCRIPTION OF THE DRAWINGS

The embodiments of the present invention will become better understood from the detailed description given herein below for illustration only, and thus are not restrictive of the present invention, and wherein:

FIG. 1 is a structural logic diagram of a WiMAX network in the prior art;

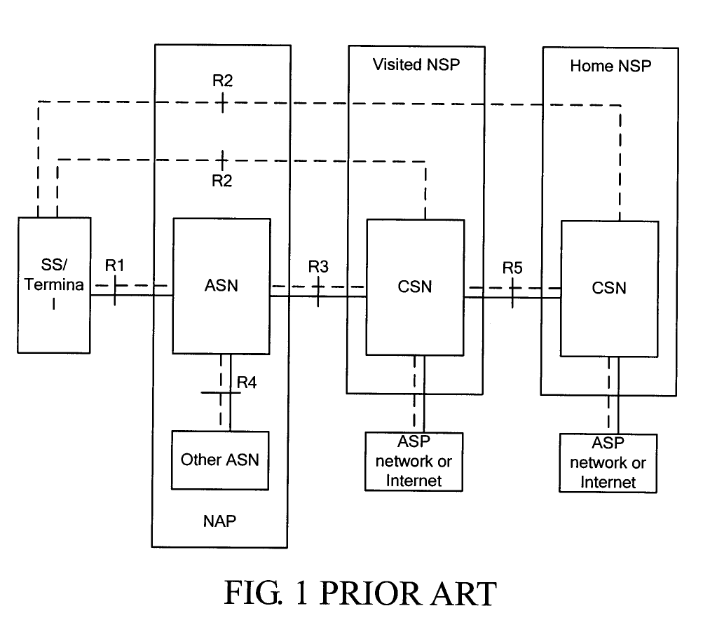

FIG. 2 is a flow chart of a method for a terminal to move in a multicast broadcast system according to a first embodiment;

FIG. 3 is a flow chart of a method for a terminal to move in a multicast broadcast system according to a second embodiment;

FIG. 4 is a flow chart of a method for a terminal to move in a multicast broadcast system according to a third embodiment;

FIG. 5 is a flow chart of a method for a terminal to move in a multicast broadcast system according to a fourth embodiment;

FIG. 6 is a flow chart of a method for a terminal to move in a multicast broadcast system according to a fifth embodiment;

FIG. 7 is a flow chart of a method for a terminal to move among different MBS zones in a multicast broadcast system according to a sixth embodiment; and

FIG. 8 is a schematic structural view of a base station according to a seventh embodiment.

### DETAILED DESCRIPTION

In the embodiments, when a terminal in an IDLE mode moves to the coverage of a target BS, if the terminal satisfies a preset report condition, the target BS is notified of the information about an MBS that the terminal needs to receive, so that the target BS is capable of acquiring the information about the MBS of the terminal in the coverage thereof, and providing the corresponding MBS to the terminal, thereby ensuring the continuity of the MBS before and after the movement of the terminal.

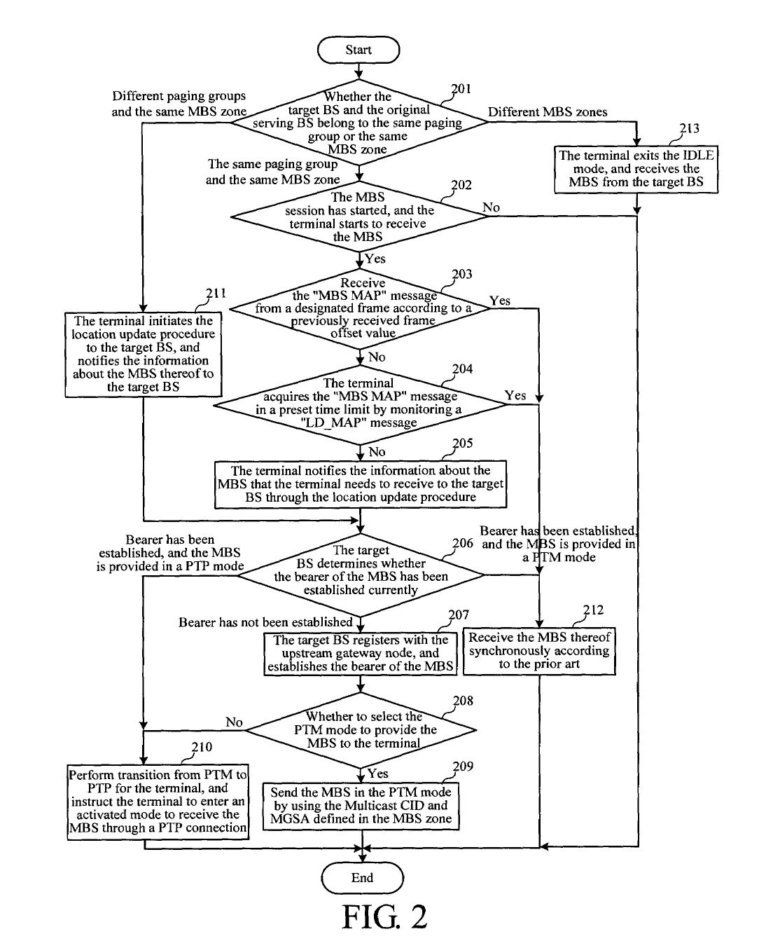

A first embodiment is described below. In the first embodiment, a method for a terminal to move in a multicast broadcast system is provided, which is applicable to a multicast broadcast system in the WiMAX system. That is, the MBS in this embodiment is the MBS based on the WiMAX system, and the details are as shown in FIG. 2.

When the terminal moves to the coverage of the target BS, Step 201 is performed, in which the terminal first determines whether the target BS and an original serving BS of the terminal belong to the same paging group and whether they belong to the same MBS zone. The terminal may determine, through monitoring the information of the target BS, whether the target BS and the original serving BS of the terminal belong to the same paging group or the same MBS zone. If the target BS and the original serving BS of the terminal belong to the same paging group and the same MBS zone, Step 202 is performed. If the target BS and the original serving BS of the terminal belong to different paging groups but the same MBS zone, Step 211 is performed, in which the terminal initiates a location update procedure to the target BS, and provides the information about the MBS of the terminal to the target BS through the location update operation. Then, Step 206 is performed, in which the target BS determines whether a bearer of the MBS is established currently. If the target BS and the original BS belong to different MBS zones, Step 213 is performed, in which the terminal exits the IDLE mode or initiates the location update procedure, receives the information about the MBS sent by the target BS, and updates the information about the MBS stored in the terminal, thereby ensuring that the terminal can receive the MBS thereof continuously from other MBS zones. The details will be described in a sixth embodiment.

If the target BS to which the terminal moves and the original BS belong to the same paging group and the same MBS zone, as illustrated in Step 202, the terminal further determines whether the current MBS session is started or not. If the service is started, that is, the terminal has received the data of the MBS, Step 203 is performed. Otherwise, the procedure ends. The details about how the terminal receives the MBS in time for the start of the service in the case where the terminal moves before the MBS starts will be described in a third, a fourth, and a fifth embodiment.

In Step 203, the terminal receives a required “MBS resource mapping (MBS MAP)” message (the message includes a multicast CID (MCID) required for receiving the service) in a designated frame according to the next MBS frame offset indicated by the “MBS MAP” message obtained before moving. If the “MBS MAP” message required by the terminal is received from the designated frame, Step 212 is performed, in which the MBS is continuously received synchronously in the same way as that in the prior art; otherwise, Step 204 is performed.

The terminal may be unsynchronized when receiving the “MBS MAP” message sent by the BS, and cannot receive the message correctly. Accordingly, in Step 204, the terminal acquires the required “MBS MAP” message by monitoring a “downlink resource map (DL_MAP)” message. If the terminal obtains the required “MBS MAP” message in a preset time limit, Step 212 is performed, in which the MBS thereof is continuously received synchronously according to the prior art. Otherwise, if the terminal does not receive the corresponding “MBS MAP” message after the preset time limit expires, it indicates that the target BS does not multicast the data of the MBS, and thus Step 205 is performed.

In Step 205, the terminal notifies the information about the MBS that the terminal needs to receive to the target BS, so as to indicate the target BS that a user of the MBS requires to receive the service currently.

The terminal may initiate the location update procedure. In the location update procedure, the terminal expands the ranging request “RNG_REQ” message so as to carry the information about the MBS currently used by the terminal, and reports the information about the MBS of the terminal through the “RNG_REQ” message. Alternatively, in the location update procedure, the terminal notifies the information about the MBS of the terminal to the BS through a “Location Update Response” message returned by an anchor paging controller (PC) to the target BS. The response message carries the information about the MBS currently used by the terminal. Thus, when the terminal enters the IDLE mode, the network side needs to send the information related to the MBS of the terminal to the anchor PC for storage. The information of the MBS includes an MBS identifier (ID), a Content ID, a Multicast CID, an MBS Group Security Association ID (MGSAID), a service flow identifier (SFID), an MBS Zone ID, an IP multicast address, and so on. Then, Step 206 is performed.

If the target BS does not provide the service, the target BS may not multicast the data of the MBS required by the terminal due to the following reasons.

a) The MBS has no data to be provided currently.

b) In the coverage of the target BS, the service data is not provided due to some other reasons, for example, no user requires to receive the MBS.

c) Since few users receive the MBS, the target BS provides the MBS data in a Point-to-Point (PTP) mode.

Therefore, in Step 206, after the target BS receives the information about the MBS of the terminal, it is determined whether the MBS is borne currently. If the MBS has been borne currently and is provided in a PTM mode (that is, when the session has been started, even the terminal does not receive any data, the only reason is that the MBS has no data to be sent temporarily), Step 212 is performed, in which the terminal waits for and receives the MBS synchronously in the same way as that in the prior art. If the MBS has been borne, but the target BS selects the PTP mode to provide the MBS, Step 210 is performed directly. If the service has not been borne yet, Step 207 is performed. Through multiple determinations, various reasons for the terminal not receiving the data of the MBS are filtered, and then are processed accordingly, thereby ensuring that the terminal receives the data of the required MBS from the target BS successfully.

Optionally, after the target BS receives the notification from the terminal, the number of users currently using the MBS in this BS may be obtained through statistics. If the MBS is transmitted in the PTP mode and the current user number exceeds a preset threshold, the transmission mode of the MBS is changed to the PTM mode.

In Step 207, if the target BS has not borne the MBS yet, the target BS registers with an upstream gateway node to require for bearing the MBS, and establishes a bearer channel for the MBS if necessary. The method for the target BS to register with the gateway node and the method for establishing the bearer channel may be obtained with reference to a session start solution in the prior art.

Step 208 is then performed, in which the BS determines whether to select the PTM mode to provide the MBS for the terminal currently according to the actual situation. If the PTM mode is selected to provide the MBS, Step 209 is performed; otherwise, if the PTP mode is selected to transmit the MBS, Step 210 is performed.

In Step 209, the target BS sends the data of the MBS in the PTM mode by using the Multicast CID and MGSAID defined by the MBS zone where the target BS belongs. The terminal may obtain the data of the required MBS only through continuing to monitor the “DL_MAP” message, thus effectively preventing the phenomenon that the terminal cannot receive the MBS for a long time after moving to the target BS from occurring.

In Step 210, the target BS selects the PTP mode to provide services to the user, and the target BS activates the user by using Paging Info obtained in the location update procedure. Thereafter, the terminal is changed from the PTM mode to the PTP mode, and is instructed to receive the data of the MBS through a PTP connection. Therefore, when the target BS transmits the data of the MBS in the PTP mode that consumes less network resources, the receiving of the MBS by the terminal moving to the coverage thereof is not interfered, thereby compensating the shortness in the prior art.

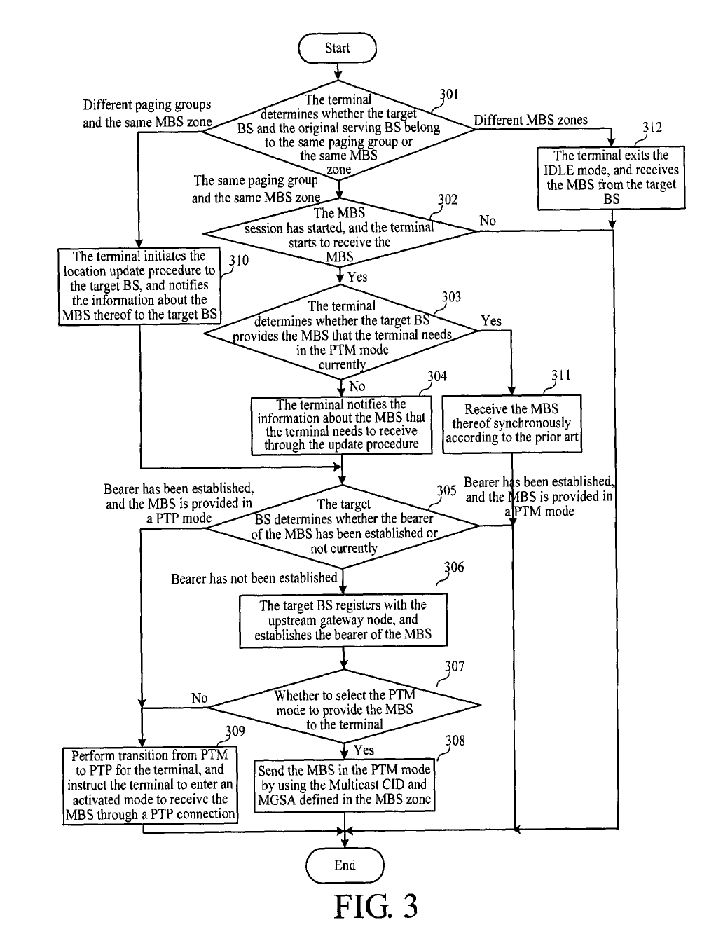

In a second embodiment of the present invention, a method for a terminal to move in a multicast broadcast system is provided, which is applicable to a multicast broadcast system in the WiMAX system. That is to say, the MBS in this embodiment is based on the WiMAX system, and details will be described with reference to FIG. 3. In this embodiment, to enable the terminal to clearly determine the situation of providing the MBS thereof in the target BS, in a broadcast signaling, the target BS clearly identifies whether the current MBS is provided and whether the service is provided in the PTM mode. In this way, the terminal is able to determine the situation of providing the required MBS, so that the terminal updates the terminal information thereof actively together with the target BS according to the actual situation. Thus, the target BS can provide the corresponding MBS to the terminal.

When the terminal moves to the coverage of the target BS, Step 301 is performed, in which the terminal first determines whether the target BS and an original serving BS of the terminal belong to the same paging group and whether they belong to the same MBS zone. The terminal may determine, through monitoring the information of the target BS, whether the target BS and the original serving BS of the terminal belong to the same paging group or the same MBS zone. If the target BS and the original BS of the terminal belong to the same paging group and the same MBS zone, Step 302 is performed. If the target BS and the original BS of the terminal belong to different paging groups but the same MBS zone, Step 310 is performed, in which the target BS is notified of the information about the MBS of the terminal through a location update operation. Then, Step 305 is performed, and the following processing is the same as that in the first embodiment. If the target BS and the original BS belong to different MBS zones, Step 312 is performed, in which the terminal exits the IDLE mode or initiates the location update procedure, receives the information about the MBS sent by the target BS, and updates the information about the MBS stored in the terminal, thereby ensuring that the terminal can receive the MBS thereof continuously from other MBS zones. The details will be described in the sixth embodiment of the present invention.

If the target BS to which the terminal moves and the original BS belong to the same paging group and the same MBS zone, in Step 302, the terminal further determines whether the current MBS session is started or not. If the service is started, that is, the terminal has been receiving the data of the MBS, Step 303 is performed. Otherwise, the procedure ends. The details about how to receive the MBS by the terminal in time for the start of the service in the case where the terminal moves before the MBS starts will be described in the third, the fourth, and the fifth embodiments.

In Step 303, the terminal determines whether the target BS provides the required MBS in the PTM mode currently according to the broadcast signaling of the target BS. If yes, Step 311 is performed, in which the MBS is received in the same way as that in the prior art; otherwise, if the target BS does not provide the MBS or provides the MBS in the PTP mode, Step 304 is thus performed.

In Step 304, the terminal notifies the information about the MBS that the terminal needs to receive to the target BS, so as to inform the target BS that a new user needs to receive the service.

The terminal may initiate the location update procedure. In the location update procedure, the terminal expands the “RNG_REQ” message, so as to carry the information about the MBS currently used by the terminal in the message, and reports the information about the MBS of the terminal through the “RNG_REQ” message. Alternatively, in the location update procedure, the terminal notifies the BS of the information about the MBS of the terminal through the “Location Update Response” message returned by an anchor PC to the target BS, in which the response message carries the information about the MBS currently used by the terminal. In this way, when the terminal enters the IDLE mode, the network side needs to send the information related to the MBS of the terminal to the anchor PC for storage. The information of the MBS includes an MBS ID, a Content ID, a Multicast CID, an MGSAID, an SFID, an MBS Zone ID, an IP multicast address, and so on.

Thereafter, Step 305 is performed, in which after the target BS receives the information about the MBS of the terminal, it is determined whether the MBS is borne currently or not. If the MBS has been borne currently and is provided in the PTM mode, the procedure ends. If the MBS has been borne, but the target BS selects the PTP mode to provide the MBS, Step 309 is performed directly. Otherwise, if the service has not been borne yet, Step 306 is performed. Through determination, various reasons for the terminal not receiving the data of the MBS are filtered, and then are processed accordingly, thereby ensuring that the terminal receives the data of the required MBS from the target BS successfully.

Steps 306 to 309 are similar to steps 207 to 210, and thus are not described again here.

In addition, as the supplementation to the first embodiment and the second embodiment, the BS may acquire the information about the MBS of the terminal in the IDLE mode through the following method. For the terminal in the IDLE mode that has joined the MBS, once it is determined that the terminal has moved to the coverage of a new BS, the terminal initiates a location update procedure, and the BS may acquire the information that the terminal has joined the MBS through the location update procedure, so as to provide the required service to the terminal.

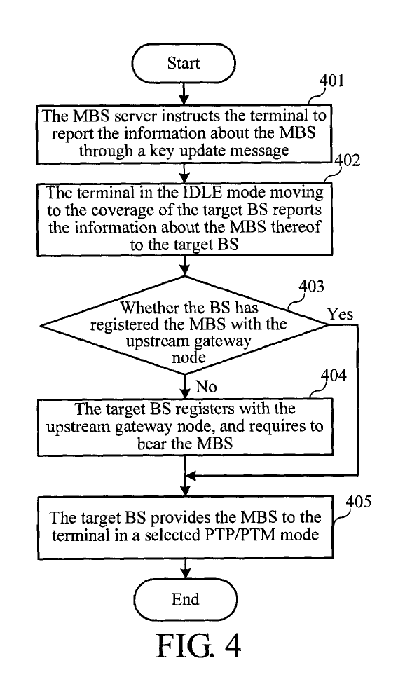

In the third embodiment of the present invention, a method for a terminal to move in a multicast broadcast system is provided, which is applicable to the WiMAX system. In this method, the MBS is based on the WiMAX system, and details will be described with reference to the FIG. 4. In this embodiment, the terminal in the IDLE mode moves to the coverage of the target BS before the MBS thereof starts. This embodiment is applicable to the MBS requiring data encryption.

In Step 401, an MBS server performs a key update for the MBS before the MBS session starts, and delivers related messages by initiating the key update procedure to instruct each terminal to report the information of the joined MBS to the BS that each terminal belongs to. Therefore, before the MBS starts, the BS is able to obtain information about the terminal using the service managed by the BS, and meanwhile determine the location of the terminal, so as to avoid the problem that the terminal newly moving to the coverage of the BS cannot receive the MBS thereof due to the nonconformity of the terminal information in the coverage known by the BS with the actual situation.

Then, Step 402 is performed, in which the terminal in the IDLE mode moving to the coverage of the target BS reports the information about the MBS thereof to the target BS after the terminal receives the message of the key update procedure.

Thereafter, Step 403 is performed. After the target BS receives the information about the MBS of the terminal, the target BS determines that a terminal requiring to receive the MBS message exists in the coverage of the BS, and determines whether this BS has registered the MBS with an upstream gateway node or not. If yes, Step 405 is performed directly; otherwise, Step 404 is performed, in which the target BS registers with the upstream gateway node, and requires bearing the MBS.

In Step 405, the target BS establishes a service bearer channel at the start of the MBS session. The target BS provides the data of the MBS to the terminal in a selected PTP/PTM mode, and the detailed method for providing the data may be obtained with reference to the prior art.

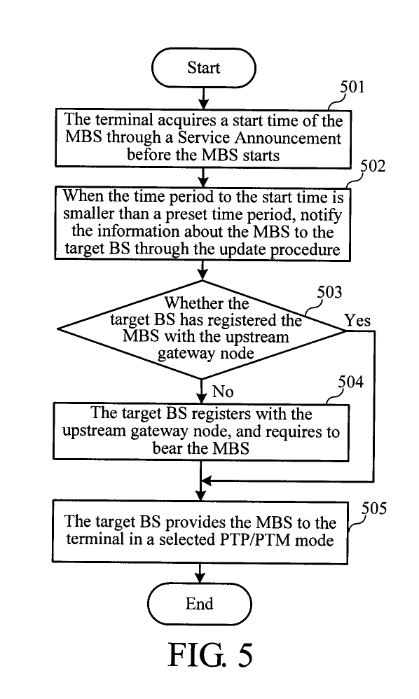

In the fourth embodiment, a method for a terminal to move in a multicast broadcast system is provided, which is applicable to the WiMAX system. In this method, the MBS is based on the WiMAX system, and details will be described with reference to FIG. 5. In this embodiment, the terminal in the IDLE mode moves to the coverage of the target BS before the MBS starts.

In Step 501, the terminal acquires a start time of the MBS though a Service Announcement before the MBS thereof starts. The terminal may acquire the start time of the MBS in various manners. For example, in addition to acquiring the start time through the Service Announcement, the start time may be provided to the terminal by the network side actively for a period of time before the session starts.

In Step 502, when a time period from a current time to the start time of the MBS is shorter than a preset time period, that is, in a preset time period before the MBS starts, the terminal initiates the location update procedure, and notifies the MBS that the terminal needs to receive to the target BS through the location update procedure. In order to avoid the problem that all the terminals initiate the location update procedure at the same time and impact to the network, the terminal may generate a delay of random length when the time period to the start time of the MBS is smaller than the preset time period, and then initiate the location update procedure after the delay. The terminal actively cooperates with the BS to update the terminal information in the coverage of the BS, thus avoiding the problem that the terminal newly moving to the coverage of the BS cannot receive the MBS thereof correctly due to the inconformity between the terminal information in the coverage thereof known by the BS and the actual information.

The terminal expands the “RNG_REQ” message in the location update procedure, carries the information about the MBS currently used by the terminal in the message, and reports the information about the MBS of the terminal through the “RNG_REQ” message. Alternatively, the terminal notifies the information about the MBS of the terminal to the BS through the “Location Update Response” message returned by the anchor PC to the target BS in the location update procedure, in which the response message carries the information about the MBS currently used by the terminal. In this way, when the terminal enters the IDLE mode, the network side needs to send the information related to the MBS of the terminal to the anchor PC for storage. The information of the MBS may include an MBS ID, a Content ID, a Multicast CID, an MGSAID, an SFID, an MBS Zone ID, an IP multicast address, or similar information.

In Step 503, after the target BS receives the information about the MBS of the terminal, it may determine whether the BS has registered the MBS with the upstream gateway node, and if yes, Step 505 is performed directly. Otherwise, Step 504 is performed, in which the target BS registers with the upstream gateway node, and requires to bear the MBS.

In Step 505, the target BS establishes a service bearer channel at the start of the MBS session, and the target BS provides the data of the MBS to the terminal in a selected PTP/PTM mode.

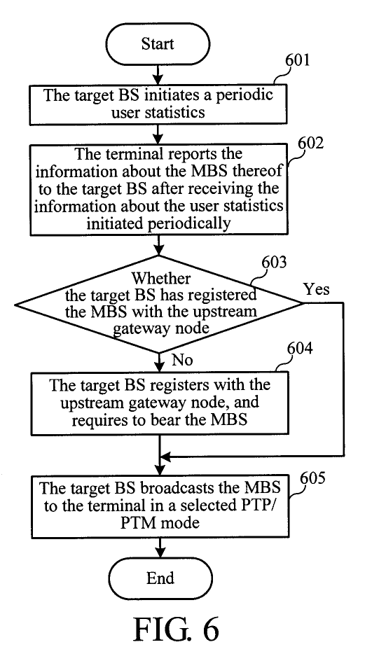

In the fifth embodiment of the present invention, a method for a terminal to move in a multicast broadcast system is provided, which is applicable to the WiMAX system. In this method, the MBS is based on the WiMAX system, and details will be described with reference to FIG. 6. In this embodiment, the terminal in the IDLE mode moves to the coverage of the target BS before the MBS thereof starts.

In Step 601, irrespective of whether the MBS session is started and whether a terminal using the MBS currently exists in the coverage of the BS, the target BS initiates a periodic user statistics. Through the user statistics, the information of the terminal in the target BS is updated, so as to ensure that the target BS provides the corresponding MBS to the terminal in time.

In Step 602, after the terminal moving to the target BS receives a user statistics message initiated periodically by the target BS, the terminal reports the information about the MBS thereof to the target BS. Then, Step 603 is performed.

Steps 603 to 605 are similar to steps 503 to 505, and thus are not described again here.

In the above solutions, the phenomenon that the terminal may not be capable of receiving the MBS after moving is determined and processed under the premise that the location update conditions of the terminal are not changed.

As an expansion of the above solutions, the conditions that the location update of the terminal is performed may also be expanded. For the terminal in the IDLE mode having joined the MBS (no matter the service starts or not), the location update procedure may be performed once as long as the BS is changed, so as to promote the terminal to report the information about the MBS thereof to the target BS after the movement, so that the network side can update the location of the terminal in time, and the corresponding target BS can provide the corresponding MBS in time.

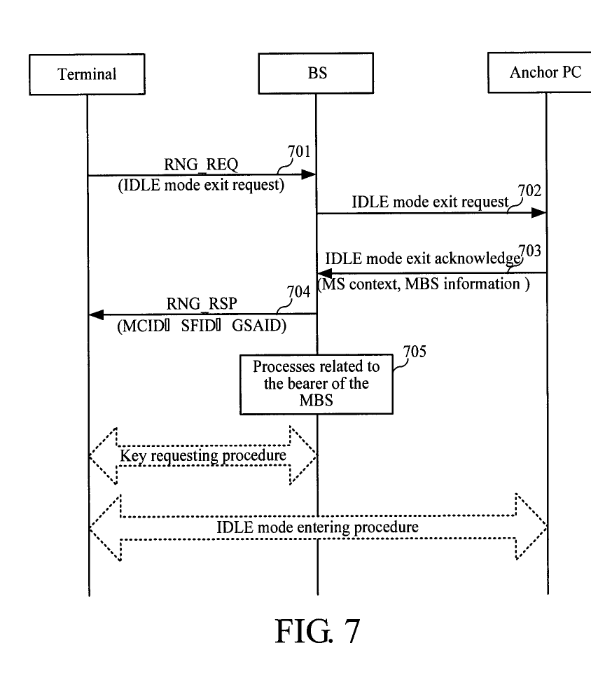

In a sixth embodiment of the present invention, the method for a terminal to move among different MBS zones is described, and details will be described with reference to FIG. 7.

When the target BS, to which the terminal moved, and the original BS belong to different MBS zones, that is, when the terminal crosses the original MBS zone during the movement, the related information about the MBS unique in the MBS zone should be updated correspondingly, such as the MBS ID, Content ID, LCID, MCID, GSAID, SFID, and MBS transmission key, so as to ensure the terminal continuously receives the MBS it is receiving. At this time, the terminal must exit the IDLE mode.

If the terminal has known that the target BS cannot bear the MBS, it is unnecessary to perform this embodiment. Otherwise, as shown in FIG. 7, in Step 701, the terminal notifies the target BS that the terminal exits the IDLE mode through an RNG_REQ message.

In Step 702, after the target BS receives the message, the target BS sends an IDLE mode exit request to the anchor PC.

In Step 703, after the anchor PC receives the request, the anchor PC returns an IDLE mode exit response message to the target BS, and carries the original information about the MBS of the terminal user in the response message.

In Step 704, the target BS may acquire the information about the MBS that the terminal is receiving or has joined through the information, and if the MBS zone of the current target BS can bear the MBS at this time, the target BS constructs a RNG_RSP message according to the corresponding information of the current MBS zone, so as to return the contents such as MBS ID, Content ID, LCID, MCID, SFID, and GSAID used by the MBS in the MBS zone to which the current BS belongs. Otherwise, if the target BS cannot bear the MBS, the target BS notifies the terminal, through the RNG_RSP message, that the target BS does not provide the MBS.

If the current target BS does not actually bear the MBS, but has the capability of bearing the MBS, Step 705 is performed, in which a service ASN of the target BS initiates the processes related to the bearing of the MBS, so as to ensure that the data of the MBS and the service information may be sent to the terminal in time.

After the terminal acquires the above content, if necessary, the terminal may initiate a key request procedure optionally, so as to acquire a transmission key of the MBS, and continuously use the service through the above contents and the transmission key of the MBS.

After acquiring the service, the terminal may initiate an IDLE mode entering procedure again to enter the IDLE mode. In an ordinary situation, when the terminal exits the IDLE mode, the information about the MBS of the terminal may be transmitted to the BS as described above, and a bearer adjustment procedure of the BS may be initiated.

As the supplementation of the sixth embodiment, a corresponding optimization procedure may exist. That is, the terminal does not exit the IDLE mode, but notifies the BS of the required MBS through the location update procedure. The notification may be performed by expanding the RNG-REQ or location update response message, which will not be described again here. The BS returns the parameters corresponding to the MBS in the MBS zone through the RNG-RSP.

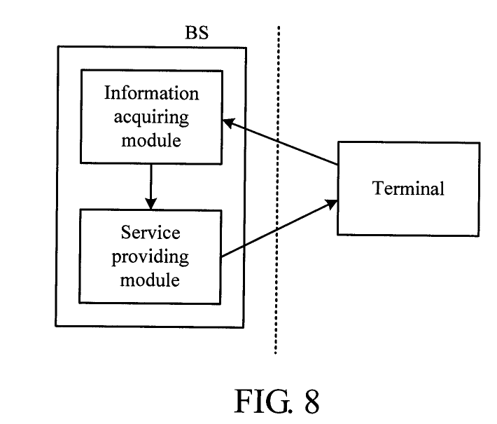

In a seventh embodiment, a BS is provided. As shown in FIG. 8, the BS includes an information acquiring module and a service providing module. The information acquiring module is adapted to acquire the information about the MBS that the terminal needs to receive when the terminal in the IDLE mode moves to the coverage of the target BS, so as to promote the BS to update the information about the MBS of the terminal in the coverage thereof, thereby avoiding the problem that the terminal newly moving to the coverage of the BS cannot receive the MBS correctly due to the nonconformity between the terminal information in the coverage thereof known by the BS and the actual information. The service providing module is adapted to register the service with an upstream gateway node when the BS does not register the MBS indicated by the information acquired by the acquiring module, establish a bearer channel of the service with the upstream gateway node, and provide the MBS to the terminal in a PTP or PTM mode.

The information acquiring module may include any one of or any combination of the following sub-modules: a module adapted to acquire the information about the MBS that the terminal needs to receive through the location update procedure initiated by the terminal, a module adapted to acquire the information about the MBS that the terminal needs to receive through the procedure of exiting the IDLE mode initiated by the terminal when crossing the MBS zone, a module adapted to acquire the information about the MBS that the terminal needs to receive through the procedure of performing periodic user statistics, and a module adapted to acquire the information about the MBS that the terminal needs to receive through the key update procedure initiated by the MBS server.

The terminal initiates the location update procedure and the acquiring module acquires the information about the MBS of the terminal when one of the following conditions is satisfied: the target BS and the original serving BS of the terminal belong to different paging groups; the MBS has started, and the terminal does not receive the data of the MBS in the coverage of the target BS; the terminal determines that the target BS does not provide the MBS or provides the MBS in the PTP mode; and a time period from the current time to a start time of the MBS that the terminal needs to receive is smaller than a preset time period. The information acquiring methods and preset conditions include the method for determining the various possibilities for the terminal being unable to receive the MBS and detection measures thereof, thereby avoiding the BS from not knowing the terminal information of the terminal moving to the coverage thereof, and ensuring that the moving terminal can receive the MBS.

Preferably, the service providing module may include one of or any combination of the following modules: a module adapted to obtain the number of users currently using the MBS transmitted in the PTP mode through statistics when the MBS has been registered, and change the transmission mode of the MBS to the PTM mode if the MBS is transmitted in the PTP mode and the number of users exceeds a preset threshold; and a module adapted to register the MBS with the upstream gateway node when the MBS is not registered, establish a bearer channel for the MBS with the upstream gateway node, and provide the MBS to the terminal in the PTP mode or PTM mode.

Preferably, the service providing module further includes a module adapted to instruct the terminal to enter an activated mode and receive the data of the MBS sent by the terminal through a PTP connection when the MBS is provided to the terminal in the PTP mode.

From the above embodiments, when the terminal in the IDLE mode moves among different paging groups, the terminal initiates the location update procedure, and the procedure notifies the information about the MBS that the terminal needs to receive to the target BS, so that the target BS can provide the corresponding MBS to the terminal according to the acquired information, thereby ensuring the continuity of the MBS when the terminal moves among different MBS zones or different paging groups, and avoiding the problem that the terminal is not served for a long time after moving.

When the terminal moves among the BSs of different MBS zones, in order to continuously receive the original MBS content, the terminal must exit the IDLE mode, and the target BS can acquire the information about the MBS that the terminal needs to receive from the anchor PC through the procedure for exiting the IDLE mode, thereby providing the corresponding MBS to the terminal.

After the MBS starts, the terminal in the IDLE mode moves from the original BS to the coverage of the target BS of the same paging group and the same MBS zone. If the terminal does not receive the data of the MBS in the coverage of the target BS, or the terminal determines that the target BS does not provide the MBS or provides the MBS in the PTP mode according to the information contained in the broadcast signaling of the target BS, the terminal provides the information about the MBS that the terminal needs to receive to the target BS through the location update procedure, so as to promote the target BS to provide the corresponding MBS to the terminal, thereby ensuring the continuity of the MBS when the terminal moves in the MBS zones after the MBS starts, and preventing the problem that the terminal is not served for a long time after the moving.

When the terminal in the IDLE mode moves from the original BS to the coverage of the target BS in the same paging group and the same MBS zone before the MBS starts, the target BS initiates the update procedure before the service starts, and commands the terminal to report the information about the MBS that the terminal needs to receive through the procedure. Therefore, the target BS can provide the corresponding MBS to the terminal in time at the start of the service, so that the normal receiving of the MBS to be started will not be affected when the terminal moves in the MBS zone.

When the time period from the current time to the start time of the MBS that the terminal needs to receive is smaller than the preset time period, the terminal reports the MBS to be received, so that the BS can provide the service normally at the start of the service, thus ensuring that the terminal can receive the MBS thereof normally when moving in the MBS zone.

When the target BS initiates the periodic user statistics, after the terminal in the IDLE mode moves from the original BS to the coverage of the target BS in the same paging group and the same MBS zone, the terminal reports the information about the MBS that the terminal needs to receive through the procedure of the user statistical operation. Therefore, the target BS can provide the corresponding MBS to the terminal in time at the start of the service, thus ensuring the normal receiving of the MBS when the terminal moves in the MBS zone.

After the target BS receives the MBS information of the terminal, if the MBS is not registered currently, the target BS registers the service with the upstream gateway node, establishes a bearer channel of the MBS with the upstream gateway node, and provides the service to the terminal in the PTP or PTM mode, thus ensuring the continuity of the service during the movement of the terminal.

If the target BS provides the MBS to the terminal in the PTP mode, the target BS instructs the terminal to enter an activated mode to establish the PTP connection for the terminal, thus enabling the terminal to receive the data of the MBS successfully.

Although the present invention is described with reference to the preferred embodiments and figures, those of ordinary skill in the art should understand that various modifications may be made to forms and details without departing from the sprit and scope of the present invention.

What is claimed is:

1. A method for a terminal to move in a multicast broadcast system, comprising:
acquiring, by a target base station (BS), information of a multicast broadcast service (MBS) that the terminal in an IDLE mode needs to receive; and
providing a corresponding MBS to the terminal according to the acquired information.

2. The method for a terminal to move in a multicast broadcast system according to claim 1, wherein the acquiring, by a target BS, information of an MBS that the terminal in an IDLE mode needs to receive comprises: acquiring, by a target base station, information of an MBS that the terminal in an IDLE mode needs to receive through a location update procedure initiated by the terminal.

3. The method for a terminal to move in a multicast broadcast system according to claim 2, wherein
the location update procedure is initiated by the terminal when the terminal satisfies a preset condition, and the preset condition comprises at least one of the following conditions:
the terminal moves to a new BS;
an original serving BS of the terminal and the target BS after movement belong to different paging groups;
the original serving BS of the terminal and the target BS after movement belong to different MBS zones;
the MBS has started, and data of the MBS has not been received by the terminal in a coverage of the target BS;
the terminal determines that the target BS does not bear the MBS or provides the MBS in a point-to-point (PTP) mode; and
a time period from a current time to a start time of the MBS that the terminal needs to receive is smaller than a preset time period.

4. The method for a terminal to move in a multicast broadcast system according to claim 3, wherein if the preset condition is that the terminal determines that the target BS does not bear the MBS or provides the MBS in the PTP mode, the method further comprises:
carrying, by the target BS, information identifying whether to bear the MBS and information for identifying a mode of providing the service in a broadcast signaling.

5. The method for a terminal to move in a multicast broadcast system according to claim 1, wherein if the original serving BS of the terminal and the target BS after movement belong to different MBS zones, the acquiring, by the target BS, the information of the MBS that the terminal in the IDLE mode needs to receive comprises:
acquiring, by the target BS, the information about the MBS that the terminal needs to receive through a procedure of exiting the IDLE mode or a location update procedure initiated by the terminal.

6. The method for a terminal to move in a multicast broadcast system according to claim 1, wherein the acquiring, by a target BS, information of a MBS that the terminal in an IDLE mode needs to receive, comprises:
acquiring, by the target BS, the information about the MBS that the terminal needs to receive through a procedure of performing a periodic user statistics; or
acquiring, by the target BS, the information about the MBS that the terminal needs to receive through a key update procedure initiated by an MBS server.

7. The method for a terminal to move in a multicast broadcast system according to claim 1, wherein if the target BS is incapable of bearing the MBS, the method further comprises:
notifying, by the target BS, the terminal that the target BS does not support the MBS.

8. The method for a terminal to move in a multicast broadcast system according to claim 2, wherein if the target BS does not register the MBS, the method further comprises:
registering, by the target BS, the MBS with an upstream gateway node;
establishing, by the target BS, a bearer channel for the service between the target BS and the upstream gateway node; and
providing, by the target BS, the service to the terminal in a point-to-point (PTP) mode or a point-to-multipoint (PTM) mode.

9. The method for a terminal to move in a multicast broadcast system according to claim 2, wherein if the target BS has registered register the MBS, the method further comprises:
obtaining the number of users currently using the MBS in the coverage of the target BS is through statistics; and
changing the transmission mode of the MBS to the PTM mode if the MBS is transmitted in the PTP mode and the number of users exceeds a preset threshold.

10. The method for a terminal to move in a multicast broadcast system according to claim 2, wherein if the target BS provides the MBS to the terminal in the PTP mode, the method further comprises:
instructing the terminal to enter an activated mode so as to receive the data of the MBS through a PTP connection.

11. The method for a terminal to move in a multicast broadcast system according to claim 1, wherein the information about the MBS comprises at least one of:
an MBS ID, a connection ID (CID), a multicast CID, an MBS Group Security Association (MBS GSA) ID, and a service flow identifier (SFID).

12. Abase station (BS), comprising:
an information acquiring module, adapted to acquire information of a multicast broadcast service (MBS) that a terminal needs to receive when the terminal in an IDLE mode moves to a coverage of a target BS; and
a service providing module, adapted to provide the MBS to the terminal according to the information acquired by the information acquiring module.

13. The BS according to claim 12, wherein the information acquiring module comprises at least one of the following:
a module, adapted to acquire the information about the MBS that the terminal needs to receive from a location update procedure initiated by the terminal;
a module, adapted to acquire the information about the MBS that the terminal needs to receive from a procedure for exiting the IDLE mode initiated by the terminal when crossing an MBS zone;
a module, adapted to acquire the information about the MBS that the terminal needs to receive from a procedure for performing a periodic user statistics; and
a module, adapted to acquire the information about the MBS that the terminal needs to receive from a key update procedure initiated by an MBS server.

14. The BS according to claim 13, wherein the terminal initiates the location update procedure and the information acquiring module acquires the information about the MBS of the terminal through the location update procedure when the terminal satisfies one of the following conditions:
the target BS and an original serving BS of the terminal belong to different paging groups;
the MBS has started, and data of the MBS has not been received by the terminal in the coverage of the target BS;
the terminal determines that the target BS does not provide the MBS or provides the MBS in a point to point (PTP) mode; and
a time period from a current time to a start time of the MBS that the terminal needs to receive is smaller than a preset time period.

15. The BS according to claim 12, wherein the service providing module comprises at least one of the following:
a module, adapted to obtain the number of users currently using the MBS transmitted in a PTP mode through statistics when the MBS has been registered, and change a transmission mode of the MBS to a point to multipoint (PTM) mode if the MBS is transmitted in a PTP mode and the number of users exceeds a preset threshold; and
a module, adapted to register the MBS with an upstream gateway node when the MBS is not registered, establish a bearer channel for the MBS with the upstream gateway node, and provide the MBS to the terminal in the PTP mode or the PTM mode.

16. The BS according to claim 15, wherein the service providing module further comprises:
a module, adapted to instruct the terminal to enter an activated mode and receive data of the MBS sent by the terminal through a PTP connection when the MBS is provided to the terminal in the PTP mode.
